(19) United States
(12) Patent Application Publication
(10) Pub. No.: US 2015/0148422 A1
(43) Pub. Date: May 28, 2015

(54) METHOD FOR PRESERVING FOOD AND METHOD FOR CLEANING SURFACES

(71) Applicant: JSK Capital, LLC, Charlotte, NC (US)

(72) Inventors: Gerald Stanley Rose, SR., Rock Hill, SC (US); Bobby Joel Ivey, Charlotte, NC (US); Kevin Aaron Rose, Ft. Mill, SC (US)

(73) Assignee: JSK Capital, LLC, Charlotte, NC (US)

(21) Appl. No.: 14/411,828

(22) PCT Filed: Jun. 28, 2013
(86) PCT No.: PCT/US13/48424

§ 371 Date: Dec. 29, 2014

Related U.S. Application Data
(60) Provisional application No. 61/666,141, filed on Jun. 29, 2012.

(51) Int. Cl. A01N 47/28; A23K 3/00

(52) U.S. Cl. CPC A01N 47/28; A23K 3/00
USPC 514/588

(57) ABSTRACT

A method for using urea sulfate as an anti-microbial agent, anti-mold agent, anti-fungal agent, and pH adjusting compound with the benefit of adding nitrogen and sulfur to the food supply. Urea sulfate provides a fundamental contribution to feed hygiene, as it suppresses the growth of mold and thus restricts the potential effect of mycotoxins. Consequently, feed safety is improved by adding this compound.

### BACKGROUND OF THE INVENTION

The present invention relates generally to food treatment agents, and more particularly, to an anti-microbial, anti-mold, anti-fungal, pH adjusting compound with the benefit of adding nitrogen and sulfur to the food supply. Additionally, the invention includes a method for cleaning all surfaces free of bacteria, including but not limited to medical equipment, animals hooves and the equipment used in the oil and gas industries.

Maintaining the quality and safety standards of human and animal food/feed is of critical importance, as well as a constant struggle. One option in this struggle is the use of anti-microbial, anti-mold, anti-fungal and pH adjusting agents that are both non-toxic if consumed and effective in preserving food quality.

Similarly, maintaining the safety and quality of medical facilities, improving the cleanliness of equipment for oil and gas processing, and reducing bacteria associated with the hooves of animals is critical. The use of anti-viral agents can be effective in this area, although these agents are often times toxic and carry safety risks of their own.

Untreated hooves of animals allow the hooves to become infected with various strains of bacteria. This causes increased infection and lesion rates in the animal which results in slower growth, reduced milk productivity or lameness.

Bacteria growth on equipment for oil fracking/drilling is also problematic because the resulting bacteria produces corrosion of the equipment. This is an expensive and time consuming problem that only an anti-microbial agent can prevent.

Accordingly, there remains a need for an improved agent that is anti-microbial, anti-mold, anti-fungal, and is a pH adjusting compound with the benefit of adding nitrogen and sulfur to the food supply, and that provides enhanced features in the quest for food preservation. Moreover, there exists the need for an improved anti-viral agent that can be used to prevent and destroy viruses from multiple surfaces, as well as address the issues discussed herein.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention; its sole purpose is to present concepts of the invention in a simplified form as a prelude to the more detailed description that is subsequently presented.

According to its major aspects and briefly stated, the present invention includes a method for using urea sulfate as an anti-microbial agent, anti-mold agent, anti-fungal agent, and pH adjusting compound with the benefit of adding nitrogen and sulfur to the food supply. Urea sulfate provides a fundamental contribution to feed hygiene, as it suppresses the growth of mold and thus restricts the potential effect of mycotoxins. Consequently, feed safety is improved by adding this compound.

Acidifiers which offer improvement in hygiene and corresponding reduction of pathogen intake, effects on feed digestion and absorption and in stabilization of gut flora eubiosis have been demonstrated in a number of investigations. In animal husbandry, higher feed conversion rates and improved daily gain, as well as reduced incidence of diarrhea, enhance economic return by lower feed costs and shorter time to market.

Inadequate pH reduction in the stomach inhibits pepsin activity and impairs protein digestion. Effective proteolytic activity requires a pH below 4, and is increased at lower pH values. This has been demonstrated in many published trials. (Eckel et al., 1992: Eidelsburger et al., 1992a; Mroz et al., 2000)

Acids generally cause irritation to mucous membranes on inhalation and can be corrosive on contact with the epidermis. The salts of urea sulfate are less corrosive. Urea sulfate is less corrosive to metals, which greatly improves the durability of equipment and storage vessels.

Urea sulfate inhibits effects of stomach and gut microbes through pH reduction and anion and proton effects in the microbial cell. Growth rates of many microbes are reduced at a pH below 5, while acid tolerant microbes are unharmed. Low pH also provides a barrier against microbes ascending from the ileum and large intestine. This reduction in pH alters cell metabolism and enzyme activity, thus inhibiting growth of intra-luminal microbes, especially pathogens.

Several investigations have demonstrated a reduction in bacterial count in the stomach due to lowering of pH. (Kluge et al., 2004, Kirchgessner and Roth, 1991; Hebeler et al., 2000). An overall, reduction in gut bacteria reduces metabolic needs of microbes and enhances absorption rates of nutrients, especially energy and amino acids (Hebeler et al., 2000; Overland et al., 2000).

Salmonella spp. survive within a pH range of 4 to 9 with an optimum range of growth from 6.5 to 7.5. Either low or high pH values in the environment will inhibit the growth of bacteria. Urea sulfate will offer a pH value below 4 while in its non-dissociated form demonstrates very low corrosion to membranes and can penetrate the bacteria cell wall by traversing the membrane and disrupting the normal processes of certain types of bacteria.

Urea sulfate provides a nitrogen and sulfur source for animal feed supplement. The addition of nitrogen and sulfur in animal feed will increase the numbers and activity of rumen bugs thus increasing rumen function which results in increases of feed eaten. (Peter Smith 2002).

Urea sulfate is certified GRAS (Generally Regarded as Safe) by US EPA under Final review case #7213 dated Nov. 18, 2010.

Thus, urea sulfate offers an alternative to in-feed antibiotics in order to enhance and secure growth performance and reduce pathogen loading.

The potential of urea sulfate lies in its ability to protect feed from microbial and fungal destruction, and its effect on stomach pH and gut flora. Acidifiers act as performance promoters by lowering pH of the gut, reducing potential proliferation of unfavorable microorganisms.

Acidification of gut stimulates enzyme activity and optimizes digestion and the absorption of nutrients and minerals. Un-dissociated forms of acid salts penetrate the lipid membrane of bacterial cells and dissociate in anions and protons. After entering the neutral pH of the cell's cytoplasm, the bacterial growth is inhibited by interrupting oxidative phosphorylation and inhibiting adenosine triphosphate-inorganic phosphate iterations. Urea sulfate will introduce nitrogen and sulfur to the diet which is essential for efficient digestion of feed or food stuffs. Urea sulfate's non-corrosive nature is an excellent alternative to harsh corrosive acids.

Additionally, the use of urea sulfate is effective against various strains of bacteria including salmonella, which can translate to use of this agent in cleaning all services, including medical cleaning applications, equipment for oil and gas processing, and reducing bacteria associated with the hooves of animals.

These and other embodiments as will be realized are provided in a method for protecting feed from microbial and fungal destruction. The method includes at least the step of adding an effective amount of urea sulfate to animal food or feed.

### DETAILED DESCRIPTION OF PREFERRED EMBODIMENT

The present invention is a method for protecting feed from microbial, mold and fungal destruction. Particularly, the method includes the step of including an effective amount of about 1% to about 15% of urea sulfate liquid to the total animal feed blend to prevent the growth of mold, microbes, fungus, and further to adjust pH with the benefit of adding nitrogen and sulfur to the food at issue. The effective amount may also be from about 1.0% to about 5.0% by weight. As used herein, the term “urea sulfate liquid” refers to urea sulfate in liquid form, which is a blend of urea, sulfuric acid and water. As used herein, “feed blend” refers to the combination of individual ingredients that make up an animal's feed, which varies depending on the nutritional needs and tastes of a particular animal. The effective amount may be calculated based on the following example: to about 100 pounds of feed blend, about 1 pound to about 5 pounds of urea sulfate is introduced for the purpose of destroying unwanted microorganisms and/or preventing their growth.

An anti-microbial effectiveness test was performed to consider the effectiveness of urea sulfate in suppressing microbial growth. The test is called “USP <51>” and refers to chapter 51 of the United States Pharmacopeia (USP), which is a detailed description of the USP method of preservative efficacy testing, which is also sometimes called “challenge testing.”

USP 51 challenges (inoculates) a formula with 5 different microorganisms, separately. Three bacteria and two fungal strains are used for each USP 51 test. Test microorganisms are grown in liquid or on solid medium, depending on the microorganism. Microorganisms used for a USP 51 test include: 1) Candida albicans (a yeast which is a form of fungus), 2) Aspergillus brasiliensis (a filamentous mold and also a fungus), 3) Escherichia coli (a bacterium better known as “E. coli”), 4) Pseudomonas aeruginosa (a bacterium that is problematic industrially), and 5) Staphylococcus aureus (a bacterium known as “Staph”).

The test microorganisms are either harvested by centrifugation from broth culture or by washing surface growth from a solid medium into a sterile vessel. The concentrations of test microorganisms are standardized by re-suspending harvested microorganisms in sterile saline to yield ˜1×10̂8 CFU/ml. In microbiology, colony-forming unit (CFU) is an estimate of viable bacterial or fungal numbers. Unlike direct microscopic counts where all cells, dead and living, are counted, CFU estimates viable cells. The appearance of a visible colony requires significant growth of the initial cells plated. At the time of counting the colonies it is not possible to determine if the colony arose from one cell or 1,000 cells. Therefore, the results are given as CFU/ml (colony-forming units per milliliter) for liquids, and CFU/g (colony-forming units per gram) for solids to reflect this uncertainty (rather than cells/ml or cells/g). A recovery analysis is performed to verify that microorganisms present in a sample can be adequately recovered and enumerated using the chosen dilution and plating scheme. A sufficient volume of test product (typically 10 ml) is distributed into each of 5 separate containers, and each container is inoculated with a separate test microorganism (mentioned above). The initial concentration of viable microorganisms in the test product is determined by standard dilution and plate count methods. Inoculated test products are incubated at 22.5±2.5° C. and sampled to determine microorganism concentration at 7, 14 and/or 28 day intervals depending on the product category into which the formulation falls. The microorganism concentration at each interval is compared to the initial concentration, and then preservative effectiveness is determined based upon USP guidelines. The USP 51 Antimicrobial Effectiveness Test specifies the initial target inoculum concentration, which allows for a fairly reproducible comparison of products that fall in the same product category. See Antimicrobial Test Laboratories description of USP 51 Test.

The USP 51 method challenges preserved products with a variety of microorganisms representing a broad spectrum of manufacturing, nosocomial and household contaminants, including gram-negative and gram-positive bacteria, yeast and mold. The initial inoculum concentration is relatively high, providing an indication of how the product will fare in “real life” should it be inadvertently contaminated with microorganisms during manufacturing or after sale.

Here, a USP 51 test was conducted with the following parameters. For preparatory method suitability, validated recovery of organisms using TSB+IAA broth. The TSB+IAA (Indole-3-acetic acid) broth is used to create the ideal bacteria growing conditions to determine if the organisms have been completely killed or just injured. Whether the organisms recover in an ideal growing condition is key. In this testing, the organisms did not recover, which is the strongest anti-microbial test result at 1:10 dilution or 10.0% and plating with SDAL & TSAL. SDA is Sabouraud dextrose agar Dextrose Culture medium for fungi. TSA is a general purpose medium, providing enough nutrients to allow for a wide variety of microorganisms to grow. It is used for a wide range of applications including culture storage, enumeration (counting), isolation of pure cultures or simply general culture (e.g. Tryptocase Soy Agar (TSA) Tryptocase Soy Broth (TSB) Nutrient Agar).

The tables below provide results from the described USB 51 test:

| Initial Inoculum Levels: | Log: | QC DATA: |
|---|---|---|
| S. aureus (ATCC 6538P) | 2.2 × 10⁵ cfu/mL = 5.34 | SDA Blank = 0 TSA blank = 0 |
| P. aeruginosa (ATOC 9027) | 2.9 × 10⁵ cfu/mL = 5.46 | SDA ÷ Saline = 0 TSA + Saline = 0 |
| E. coli (ATCC 8739) | 5.0 × 10⁵ cfu/mL = 5.70 | SDA ÷ Saline + Tween 80 = 0 TSAL = 0 |
| C. albicans (ATCC 10231) | 9.4 × 10⁵ cfu/mL = 5.97 | SDA = 0 TSAL + Saline = 0 |
| A. brasiliensis (ATCC 16404) | 2.6 × 10⁵ cfu/mL = 5.41 | SDAL + Saline + Tween 80 = 0 |

Log 10 Change from Initial Spike Results

| Client | Log | Log | Log | Log | Log | Log | Log C | Log | Log A | Log |
|---|---|---|---|---|---|---|---|---|---|---|
| Marks | Saureus | Change | P. aeruginosa | Change | E. coli | Change | albicans | Change | brasiliensis | Change |
| Day 1 | <1 | >*4.34 | <1 | >*4.46 | <1 | >*4.70 | <1 | >*4.97 | <1 | >*4.97 |
| Day 7 | <1 | >*4.34 | <1 | >*4.46 | <1 | >*4.70 | <1 | >*4.97 | <1 | >*4.97 |
| Day | <1 | >*4.34 | <1 | >*4.46 | <1 | >*4.70 | <1 | >*4.97 | <1 | >*4.97 |
| 14 | | | | | | | | | | |
| Day | <1 | >*4.34 | <1 | >*4.46 | <1 | >*4.70 | <1 | >*4.97 | <1 | >*4.97 |
| 28 | | | | | | | | | | |

*= decrease in log 10 of organism

These results were unexpected, as the urea sulfate agent was shown to be effective on all, rather than only some, major categories of bacteria, fungi and mold. Particularly, after a month, there was no measurable change identified in the amounts of Candida albicans, Aspergillus brasiliensis, Escherichia coli, Pseudomonas aeruginosa, and Staphylococcus aureus.

Additionally, the use urea sulfate is effective against various strains of bacteria including salmonella, which can translate to use of this agent in cleaning all surfaces, including medical cleaning applications, equipment for oil and gas processing, and reducing bacteria associated with the hooves of animals.

In one embodiment, the present invention is a method for treating feed from microbial, mold and fungal destruction, as well as for adjusting the pH and introducing nitrogen and sulfur, comprising the steps of: 1) providing an amount of feed blend; and 2) providing an effective amount of urea sulfate to the amount of feed blend. Preferably, the effective amount is about 1.0% to about 5.0% of urea sulfate in liquid solution.

In another embodiment, the present invention is a method for cleaning surfaces, comprising the steps of: 1) providing a surface being contaminated with an amount of bacteria; 2) providing an effective amount of urea sulfate; and 3) introducing the effective amount of urea sulfate to the contaminated surface to destroy the amount of bacteria. Preferably, the effective amount is about 1.0% to about 5.0% of urea sulfate in liquid solution.

Those skilled in the art of anti-microbial agents and the chemical arts will appreciate from the foregoing description of preferred embodiments that substitutions and modification can be made without departing from the spirit and scope of the invention which is defined by the appended claims.

What is claimed is:

1. A method for treating feed from microbial, mold and fungal destruction, as well as for adjusting the pH and introducing nitrogen and sulfur, comprising the steps of:
providing an amount of feed blend; and
providing an effective amount of urea sulfate to said amount of feed blend.

2. The method as recited in claim 1, wherein said effective amount is about 1% to about 15% by weight of said urea sulfate to said feed blend.

3. The method as recited in claim 1, wherein said effective amount is about 1.0% to about 5.0% by weight of said urea sulfate to said feed blend.

4. The method as recited in claim 1, wherein said effective amount is about 1.0% to about 3.0% by weight of said urea sulfate to said feed blend.

5. A method for cleaning surfaces, comprising the steps of:
providing a surface being contaminated with an amount of bacteria;
providing an effective amount of urea sulfate;
introducing said effective amount of urea sulfate to said contaminated surface to destroy said amount of bacteria.

6. The method as recited in claim 5, wherein said effective amount is about 1% to about 15% by weight of urea sulfate.

7. The method as recited in claim 5, wherein said effective amount is about 1.0% to about 5.0% by weight of said urea sulfate.

8. A method for cleaning, comprising the steps of:
providing an amount of microorganisms;
introducing an effective amount of urea sulfate to said amount of microorganisms; and
preventing with said effective amount of urea sulfate said amount of amount of microorganisms from increasing following said introducing step.

9. The method as recited claim 8, wherein said amount of microorganisms includes Candida albicans, Aspergillus brasiliensis, Escherichia coli, Pseudomonas aeruginosa, or Staphylococcus aureus.

10. The method as recited in claim 8, wherein said introducing step is done to the hooves of animals.

11. The method as recited in claim 8, wherein said effective amount is about 1% to about 15% by weight of said urea sulfate.

12. The method as recited in claim 8, wherein said effective amount is about 1.0% to about 5.0% by weight of said urea sulfate.
